(19) United States
(12) Patent Application Publication
(10) Pub. No.: US 2026/0181108 A1
(43) Pub. Date: Jun. 25, 2026

(54) METHOD AND APPARATUS FOR ADDRESSING CMS FAULT CONDITIONS

(71) Applicant: Stoneridge Electronics AB, Solna (SE)

(72) Inventors: Banuprakash Murthy, Novi, MI (US); Arunshankar Dhandayuthapany, Auburn Hills, MI (US); Girikrishna Talla, Novi, MI (US)

(21) Appl. No.: 18/999,502

(22) Filed: Dec. 23, 2024

(51) Int. Cl. H04N 7/18; B60R 1/27; G08G 1/16

(52) U.S. Cl. CPC H04N 7/181; B60R 1/27; G08G 1/167; B60R 2300/105; B60R 2300/607

(57) ABSTRACT

A method for operating a camera monitor system includes receiving at an electronic control unit (ECU) images of an environment surrounding a commercial vehicle from a first camera and a second camera. Based upon detection of a fault condition related to the first camera, the first image feed is replaced on the display with a synthetic view generated based upon sensor signals from at least one distance sensor. A camera monitor system (CMS) includes: a first camera; a second camera; a first display; a second display; at least one distance sensor; and an ECU including at least one processor and at least one storage. Based on detection of a fault condition related to the first camera, a first image feed on the first display is replaced with a synthetic view generated based upon sensor signals from the at least one distance sensor.

### TECHNICAL FIELD

This disclosure relates to a camera monitor system (CMS), and more particularly to a method and apparatus for addressing CMS fault conditions.

### BACKGROUND

Vehicle camera systems for mirror replacement or for supplementing mirror views are utilized in commercial vehicles to enhance the ability of a vehicle operator to see a surrounding environment. Camera monitor systems (CMS) utilize one or more cameras to provide an enhanced field of view to a vehicle operator. In some examples, the mirror replacement systems cover a larger field of view than a conventional mirror or include views that are not fully obtainable via a conventional mirror.

A CMS can be very useful to a driver when operating properly, however if a fault condition occurs this may present challenges for a driver that is accustomed to relying on the CMS for navigation.

### SUMMARY

In some aspects, the techniques described herein relate to a method for operating a camera monitor system including: receiving at an electronic control unit (ECU) images of an environment surrounding a commercial vehicle from a first camera and a second camera, wherein the first camera and the second camera are disposed on the commercial vehicle. The ECU receives sensor signals from at least one distance sensor mounted on the commercial vehicle. A first image feed from the first camera is displayed on a first display. A second image feed from the second camera is displayed on a second display that is separate from the first display. Based upon detection of a fault condition related to the first camera, the first image feed is replaced on the first display with a synthetic view generated based upon the sensor signals from the at least one distance sensor.

The at least one distance sensor may be at least one of radar, lidar, or ultrasonic.

The synthetic view may be generated based upon an image feed from a third camera.

The synthetic view may be a bird's eye view.

In some aspects, the techniques described herein relate to a method, wherein the ECU generates the synthetic view in response to detection of the fault.

In some aspects, the techniques described herein relate to a method, wherein the synthetic view is generated based upon an image feed from a third camera.

In some aspects, the techniques described herein relate to a method, wherein the ECU generates the synthetic view in response to detection of the fault.

In some aspects, the techniques described herein relate to a method wherein the synthetic view is a bird's eye view.

In some aspects, the techniques described herein relate to a method wherein the ECU instructs a driver of the commercial vehicle to perform a recommended maneuver in response to the detection of the fault.

In some aspects, the techniques described herein relate to a method wherein the recommended maneuver includes changing lanes toward an area proximate the commercial vehicle toward which the first camera is directed.

In some aspects, the techniques described herein relate to a camera monitor system (CMS), including: a first camera; a second camera; a first display; a second display; at least one distance sensor; and an electronic control unit (ECU) including at least one processor and at least one storage. The at least one storage stores instructions which when executed by the at least one processor cause the CMS to: receive a first image feed from the first camera and receive a second image feed from the second camera. The first image feed and second image feed depict an environment proximate a commercial vehicle. The first image feed is displayed on the first display and the second image feed is displayed on the second display. Sensor signals are received from the at least one distance sensor. Based on detection of a fault condition related to the first camera, the first image feed on the first display is replaced with a synthetic view generated based upon the sensor signals from the at least one distance sensor.

The synthetic view may be generated based upon a third image feed from a third camera.

The at least one distance sensor may include one or more of: radar, lidar or ultrasound.

In some aspects, the techniques described herein relate to a camera monitor system wherein the instructions further cause the CMS to generate the synthetic view in response to the detection of the fault.

In some aspects, the techniques described herein relate to a camera monitor system, wherein the instructions further cause the CMS to instruct a driver of the commercial vehicle to perform a recommended maneuver.

In some aspects, the techniques described herein relate to a camera monitor system wherein the recommended maneuver includes changing lanes toward an area proximate the commercial vehicle toward which the first camera is directed.

In some aspects, the techniques described herein relate to a camera monitor system wherein the first camera is mounted to a first side of the commercial vehicle and the second camera is mounted to an opposite side of the commercial vehicle.

In some aspects, the techniques described herein relate to a camera monitor system wherein the at least one distance sensor is mounted to the first side of the commercial vehicle.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The disclosure can be further understood by reference to the following detailed description when considered in connection with the accompanying drawings wherein:

FIG. 1 is a schematic front view of a commercial vehicle with a camera mirror system (CMS) used to provide at least Class II and Class IV views.

FIG. 2 is a schematic top view of the commercial vehicle of FIG. 1.

FIG. 3 is a schematic top view of an example vehicle cabin that could be used in the commercial vehicle of FIG. 1.

FIG. 4 is a perspective view of the vehicle cabin of FIG. 3.

FIG. 5A is a schematic view of a first electronic display from FIGS. 1-4.

FIG. 5B is a schematic view of a second electronic display from FIGS. 1-4.

FIG. 6 is a flowchart of an example method for operating a CMS.

FIG. 7 shows the second electronic display of FIG. 5B in a remedial mode.

### DETAILED DESCRIPTION

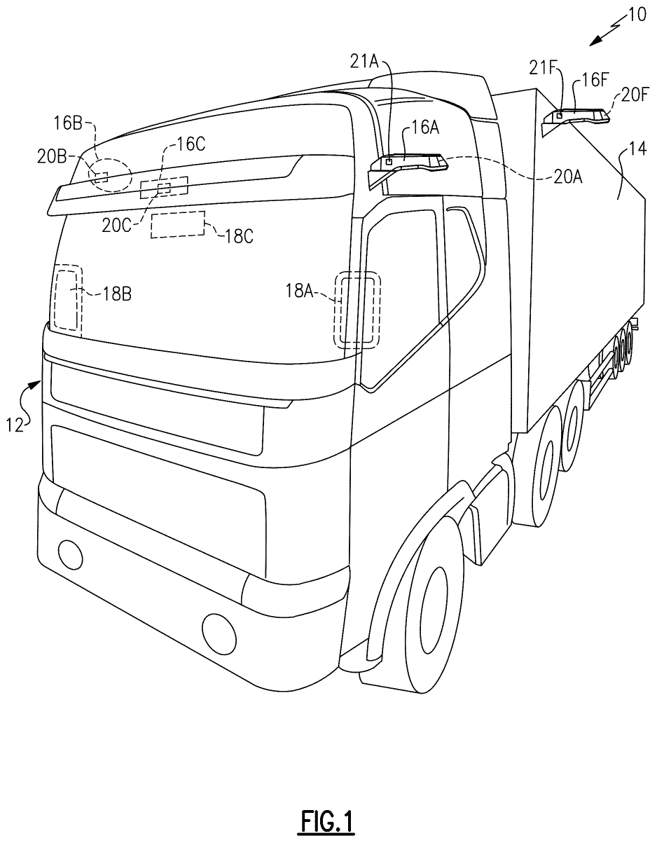

Schematic views of a commercial vehicle 10 are illustrated in FIGS. 1-4. The commercial vehicle 10 includes a vehicle cab or tractor 12 for pulling a trailer 14, where the trailer 14 pivots with respect to the tractor 12 during turns. Although the commercial vehicle 10 is depicted as a commercial truck with a single trailer in this disclosure, it is understood that other commercial vehicle configurations may be used (e.g., different types or quantities of trailers).

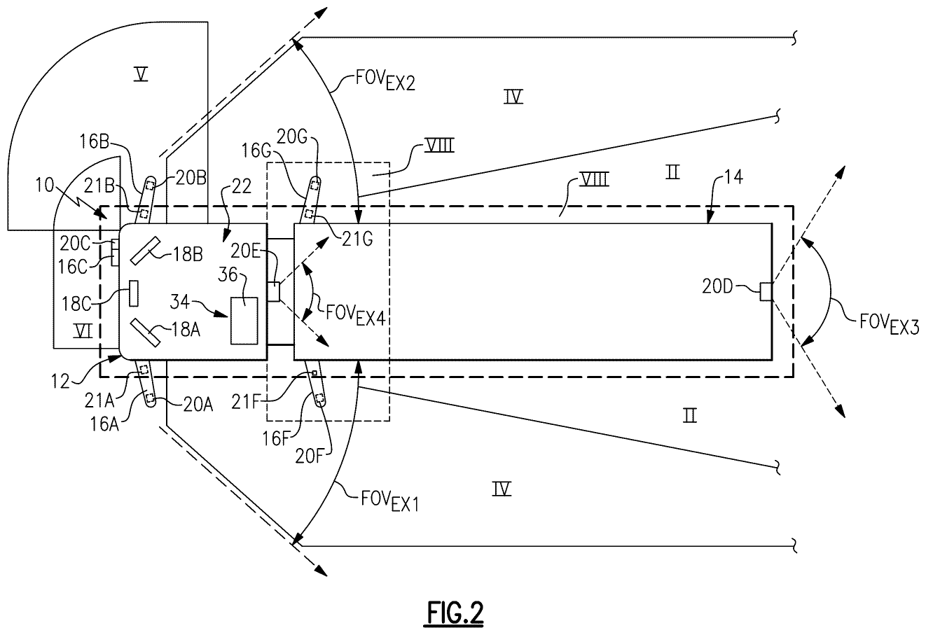

A pair of camera arms 16A-B each include a respective base that is secured to opposite sides of the tractor 12. A pivoting arm is supported by the base and may articulate relative thereto. At least one rearward facing camera 20A-B (generally, camera 20) is arranged respectively within the camera arms 16A-B. The exterior cameras 20A-B respectively provide an exterior field of view FOV_{EX1}, FOV_{EX2} that each include at least one of Class II and Class IV views (FIG. 2), which are legal prescribed views in the commercial trucking industry.

The Class II view on a given side of the commercial vehicle 10 is a subset of the class IV view of the same side of the commercial vehicle 10. Alternatively, multiple cameras may be used in each camera arm 16A-B to provide these views, if desired. Class II (narrow) and Class IV (wide angle) views are defined in European R46 legislation, for example, and the United States and other countries have similar drive visibility requirements for commercial trucks. Any reference to a “Class” view is not intended to be limiting but is intended as exemplary for the type of view provided to a display by a particular camera.

Each camera arm 16A-16B may also provide a housing that encloses electronics, e.g., a controller, that are configured to provide various features of the CMS 15, and/or one or more object detection sensors (e.g., ultrasonic, radar, or lidar). The camera arms 16A-B may be mounted either at a roof-mount location over the cab door (as shown), or on a door-mounted bracket or station, for example. Each camera arm 16A-16B may also have a distance sensor 21A-21B mounted therein. The distance sensor 21A-21B may include radar, lidar, ultrasound or a combination of these sensors. The distance sensor 21A-21B could also be mounted to the tractor 12 separately from the camera arms 16A-16B. Either way, the distance sensor 21A is directed toward the same general area proximate the commercial vehicle 10 as is the camera 20A and the distance sensor 21B is directed toward the same general area proximate the commercial vehicle 10 as is the camera 20B.

If video of Class V and Class VI views are also desired, a camera housing 16C and camera 20C may be arranged at or near the front of the commercial vehicle 10 to provide those views (FIG. 2).

A backup camera 20D may be provided which provides a field of view FOV_{EX3}. The backup camera 20D may be mounted at a top/centerline of the trailer, at a bumper/bed level of the trailer, or at a top-corner of the back of the trailer, for example. Alternatively, or in addition to the rear trailer camera, a “fifth wheel camera” 20E may be provided that is mounted to a rear of the tractor 12 and that provides a field of view FOV_{EX4}. The fifth wheel camera 20E may be mounted anywhere between the lateral plane of the fifth wheel fixture and the top/roof edge of the tractor, for example.

Referring to FIGS. 1 and 2, an optional trailer-mounted camera arm 16F may be mounted to one side of the trailer 14 and an optional trailer-mounted camera arm 16G may be mounted to the opposite side of the trailer 14. Each trailer-mounted camera arm 16F-16G includes a camera 20F-20G and optionally, a distance sensor 21F-21G, respectively. The distance sensor 21F-21G may include radar, lidar, ultrasound or a combination of these sensors. The distance sensor 21F is directed toward the same general area proximate the commercial vehicle 10 as is the camera 20F and the distance sensor 21G is directed toward the same general area proximate the commercial vehicle 10 as is the camera 20G.

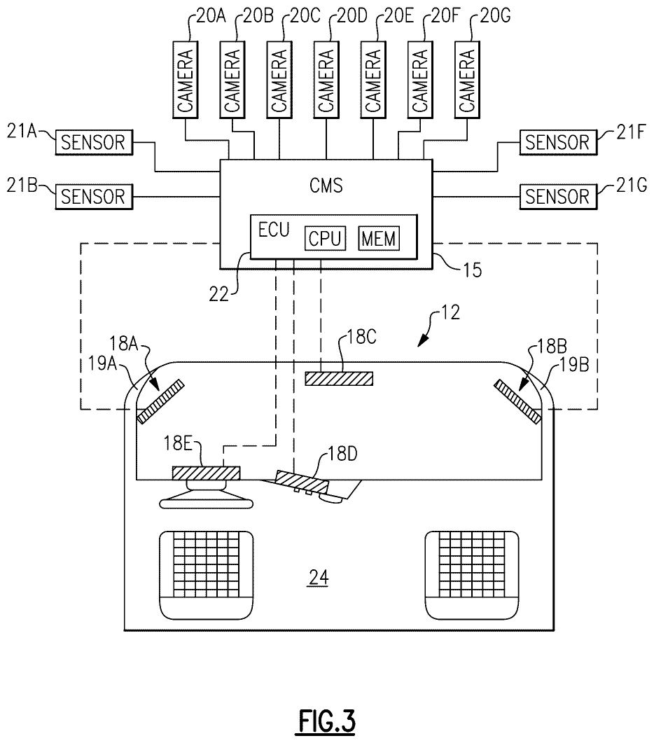

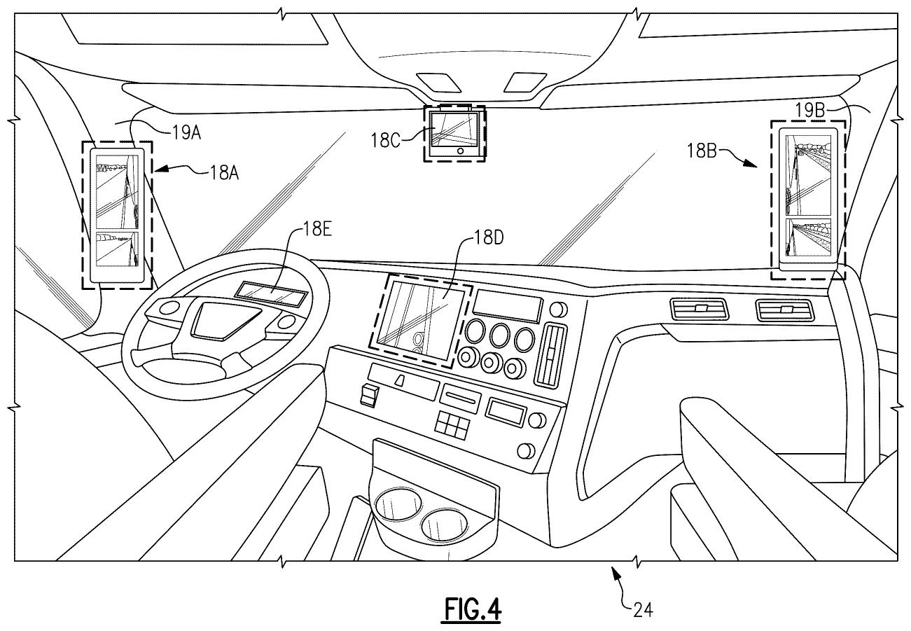

FIG. 3 is a schematic top view of an example vehicle cabin 24, and FIG. 4 is a perspective view of the vehicle cabin 24. Referring now to FIGS. 3-4 with continued reference to FIGS. 1-2, electronic displays 18A-E (e.g., which may be video displays, such as LCD displays) and cameras 20A-G are shown. A camera monitor system or CMS 15 includes the camera arms 16A-B mounted to the outside of the tractor 12 (FIG. 1), at least cameras 20A-B, distance sensors 21A-B, and at least electronic displays 18A-B are part of a CMS 15. The displays 18C-E, distance sensors 21F-G, and cameras 20C-G may be part of the CMS 15 or may be part of a native vehicle camera system that is separate from the CMS 15.

The CMS 15 includes a CMS electronic control unit (ECU) 22 that includes processing circuitry that supports operation of the CMS 15 and is operatively connected to at least one storage, such as memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include at least one processor such as one or more microprocessors, microcontrollers, application specific integrated circuits (ASICs), or the like. The at least one storage stores instructions, which when executed by the at least one processor causes the CMS 15 to perform the functions described herein.

The electronic displays 18A-B are arranged on each of the driver and passenger sides within the tractor 12 on or near the A-pillars 19A-B to display Class II and Class IV views on its respective side of the commercial vehicle 10, which provide rear facing side views along the commercial vehicle 10 that are captured by the exterior cameras 20A-B.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged within the tractor 12 near the top center of the windshield may be used to display the Class V and Class VI views, which are toward the front of the commercial vehicle 10, or a backup camera view (from camera 20D or 20E) to the driver. Display 18D is provided in a center console area of the cabin 24, and may be used for other purposes, such as navigation, infotainment, etc. Display 18E may be part of an instrument cluster, for example. The displays 18A, 18B, 18C face a driver region within the cabin 24 where an operator is seated on a driver seat.

If desired, the camera arms 16A-B may include conventional mirrors integrated with them as well, although the CMS 15 may be used to entirely replace mirrors. In additional examples, each side can include multiple camera arms, each arm housing one or more cameras and/or mirrors.

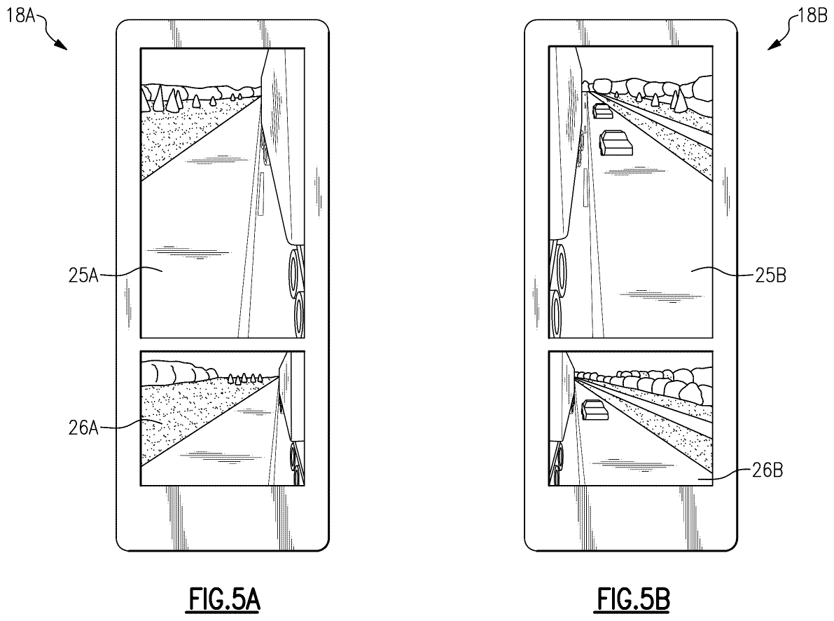

FIG. 5A is a schematic view of the electronic display 18A from FIGS. 1-4, and FIG. 5B is a schematic view of the electronic display 18B from FIGS. 1-4. Each display 18A-B includes a respective first display area 25A-B and a respective second display area 26A-B. In the example of FIGS. 5A-B, display area 25A is configured to display a Class II view from camera 20A, and display area 26A is configured to display a Class IV view from camera 20A (or an additional, wide angle camera situated on the same side of the commercial vehicle as camera 20A). Similarly, display area 25B is configured to display a Class II view from camera 20B, and display area 26B is configured to display a Class IV view from camera 20B (or an additional, wide angle camera situated on the same side of the commercial vehicle as camera 20B).

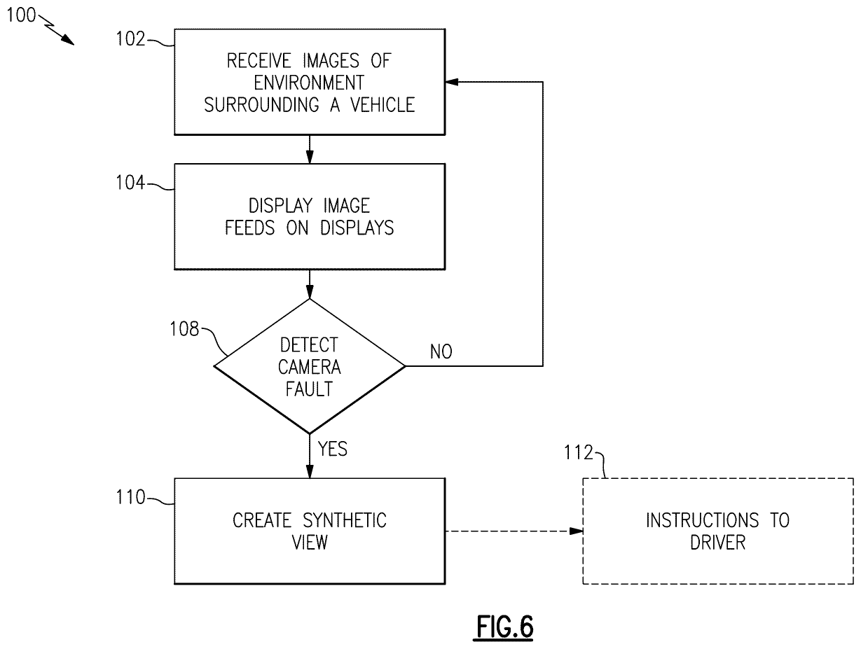

FIG. 6 is a flowchart of one example method 100 for operating a CMS, such as the CMS 15 of FIG. 3. The ECU 22 obtains images of an environment surrounding a commercial vehicle (e.g., Class II and/or Class IV views) from the first camera 20A and the second camera 20B, wherein the first camera and the second camera are disposed on opposing sides of commercial vehicle 10 (step 102). The ECU 22 may also obtain images from camera 20C, backup camera 20D, fifth wheel camera 20E, and trailer-mounted cameras 20F and 20G.

In step 104, the ECU 22 displays an image feed from the camera 20A on display 18A and displays a second image feed from the camera 20B on display 18B that is separate from the display 18A. The ECU 22 may display image feeds from one or more of camera 20C, backup camera 20D, fifth wheel camera 20E, and trailer-mounted cameras 20F and/or 20G on the displays 18C, 18D, 18E.

In step 108, the ECU 22 determines whether the CMS 15 is experiencing a fault condition related to one of the cameras 20, e.g. the ECU 22 is not receiving a valid signal from one of the cameras 20. If the CMS 15 is not experiencing a camera fault condition (a “no” to step 108), the method 100 proceeds back to step 102. However, if the CMS ECU 22 detects a fault condition of one of the cameras 20 (a “yes” to step 108), a synthetic view is created by the ECU 22 (step 110) to replace the view from the faulty camera 20 and provide that synthetic view to the display 18 to which the feed of the faulty camera 20 had been previously provided. The ECU 22 continues to provide the image feeds from any cameras 20 not experiencing a fault to their respective displays 18. The ECU 22 may generate the synthetic view in response to the detection of the fault condition, or the ECU 22 may already be generating the synthetic view prior to detection of the fault condition and simply provides it to the associated display in response to the detection of the fault condition.

Optionally, or alternatively, the ECU 22 may also provide instructions to the driver via one or more of the displays 18 and/or voice instructions to alleviate concerns related to the view that is missing. The instructions may include a recommended maneuver. For example, the ECU 22 may provide instructions to the driver to change lanes in a direction toward the area of the surrounding environment of the commercial vehicle 10 to which the faulty camera 20 was previously directed. By moving into the furthest lane in the direction of the faulty camera, the relevance of the reduced information from the faulty camera 20 is reduced.

The synthetic view created in step 110 may be an overhead or “bird's eye” view of the commercial vehicle 10, including a representation of a top of the tractor 12 and a top of the trailer 14, representations of the lane lines, and representations of any detected objects in the surrounding environment of the commercial vehicle 10, such as other vehicles. The ECU 22 creates the synthetic view based upon information from the remaining cameras 20 and based upon the distance sensors 21, including the distance sensors 21 that overlap at least partially with the field of view previously provided by the faulty camera 20. Many different methods for creating synthetic views, such as overhead or bird's eye views, are well known, and any of these could be used to create synthetic views in the present method.

If there is sufficient information from the available cameras 20, an augmented image of an object (e.g. another vehicle) is provided in the relevant location within the synthetic view. If there is insufficient information available from the available cameras 20, and the location of the object is detected only by one or more distance sensors 21, then a representative icon or animated image may be placed in the detected location of the object relative to the commercial vehicle 10. The image feed is updated continuously based upon continuous monitoring of the distance sensors 21 to illustrate an updated current position of the object relative to the commercial vehicle 10.

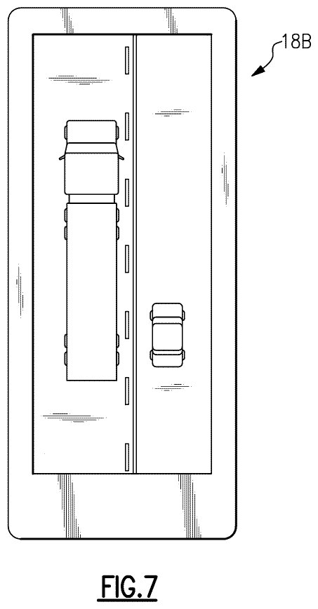

For example, referring to FIG. 2, if the camera 20B failed or the ECU 22 otherwise failed to receive a valid signal from the camera 20B, the ECU 22 would create a synthetic view, such as a bird's-eye view or overhead view, based upon sensor signals from the distance sensors 21A, 21B, 21F and/or distance sensor 21G. The ECU 22 may also generate the synthetic view based upon the image(s) received from cameras 20A, 20C, 20D, 20E, 20F, and/or camera 20G. Referring to FIG. 7, the synthetic view is sent to display 18B, which is where the image feed from faulty camera 20B would have been displayed.

Optionally, in step 112, because the faulty camera 20B is on the right of the commercial vehicle 10, the ECU 22 generates instructions to the driver to change lanes all the way to the right. While the commercial vehicle 10 is in the far right lane, the lack of complete visibility to the right from camera 20B will be less important. The instructions may be provided to the driver from the ECU 22 via text on one or more displays 18, or more preferably via voice commands.

Similarly, if camera 20A failed, the ECU 22 would create a synthetic view (such as a bird's eye view) based upon sensor signals from the distance sensors 21A, 21B, 21F and/or distance sensor 21G. The ECU 22 may also generate the synthetic view based upon the image(s) received from cameras 20B, 20C, 20D, 20E, 20F, and/or camera 20G. The ECU 22 would provide this synthetic view to display 18A. Then, optionally, or alternatively, in step 112 the ECU would generate instructions to the driver to change lanes all the way to the left.

If camera 20D failed, the ECU 22 would create a synthetic view (such as a bird's eye view) based upon sensor signals from the distance sensors 21A, 21B, 21F and/or distance sensor 21G. The ECU 22 may also generate the synthetic view based upon the image(s) received from cameras 20A, 20B, 20C, 20E, 20F, and/or camera 20G. The ECU 22 would provide this synthetic view to display 18D. In this example, step 112 would not be performed.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers for operations or method steps are for ease of reference in dependent claims and do not indicate a required sequence unless explicitly stated.

1. A method for operating a camera monitor system comprising:
receiving at an electronic control unit (ECU) images of an environment surrounding a commercial vehicle from a first camera and a second camera, wherein the first camera and the second camera are disposed on the commercial vehicle;
receiving at the ECU sensor signals from at least one distance sensor mounted on the commercial vehicle;
displaying a first image feed from the first camera on a first display;
displaying a second image feed from the second camera on a second display that is separate from the first display; and
based upon detection of a fault condition related to the first camera, replacing the first image feed on the first display with a synthetic view generated based upon the sensor signals from the at least one distance sensor.

2. The method of claim 1, wherein the at least one distance sensor includes at least one of radar, lidar, or ultrasonic.

3. The method of claim 2, wherein the synthetic view is generated based upon an image feed from a third camera.

4. The method of claim 3 wherein the synthetic view is a bird's eye view.

5. The method of claim 4, wherein the ECU generates the synthetic view in response to detection of the fault.

6. The method of claim 1, wherein the synthetic view is generated based upon an image feed from a third camera.

7. The method of claim 1, wherein the ECU generates the synthetic view in response to detection of the fault.

8. The method of claim 1 wherein the synthetic view is a bird's eye view.

9. The method of claim 1 wherein the ECU instructs a driver of the commercial vehicle to perform a recommended maneuver in response to the detection of the fault.

10. The method of claim 9 wherein the recommended maneuver includes changing lanes toward an area proximate the commercial vehicle toward which the first camera is directed.

11. A camera monitor system (CMS), comprising:
a first camera;
a second camera;
a first display;
a second display;
at least one distance sensor; and
an electronic control unit (ECU) including at least one processor and at least one storage, the at least one storage storing instructions which when executed by the at least one processor cause the CMS to:
receive a first image feed from the first camera and receive a second image feed from the second camera, wherein the first image feed and second image feed depict an environment proximate a commercial vehicle;
display the first image feed on the first display and display the second image feed on the second display;
receiving sensor signals from the at least one distance sensor; and
based on detection of a fault condition related to the first camera replacing the first image feed on the first display with a synthetic view generated based upon the sensor signals from the at least one distance sensor.

12. The camera monitor system of claim 11, wherein the synthetic view is generated based upon a third image feed from a third camera.

13. The camera monitor system of claim 11, wherein the at least one distance sensor includes one of radar, lidar or ultrasound.

14. The camera monitor system of claim 11 wherein the instructions further cause the CMS to generate the synthetic view in response to the detection of the fault condition.

15. The camera monitor system of claim 11, wherein the instructions further cause the CMS to instruct a driver of the commercial vehicle to perform a recommended maneuver.

16. The camera monitor system of claim 15 wherein the recommended maneuver includes changing lanes toward an area proximate the commercial vehicle toward which the first camera is directed.

17. The camera monitor system of claim 11 wherein the first camera is mounted to a first side of the commercial vehicle and the second camera is mounted to an opposite side of the commercial vehicle.

18. The camera monitor system of claim 17 wherein the at least one distance sensor is mounted to the first side of the commercial vehicle.

19. A method for operating a camera monitor system comprising:
receiving at an electronic control unit (ECU) images of an environment surrounding a commercial vehicle from a first camera and a second camera, wherein the first camera and the second camera are disposed on the commercial vehicle;
receiving at the ECU sensor signals from at least one distance sensor mounted on the commercial vehicle;
displaying a first image feed from the first camera on a first display;
displaying a second image feed from the second camera on a second display that is separate from the first display; and
based upon detection of a fault condition related to the first camera, the ECU instructing a driver of the commercial vehicle to perform a recommended maneuver in response to the detection of the fault.

20. The method of claim 19 wherein the recommended maneuver includes changing lanes toward an area proximate the commercial vehicle toward which the first camera is directed.

21. The method of claim 19 wherein the fault condition related to the first camera is the ECU not receiving a valid signal from the first camera.

22. The method of claim 1 wherein the fault condition related to the first camera is the ECU not receiving a valid signal from the first camera.

23. The camera monitor system of claim 11 wherein the fault condition related to the first camera is the ECU not receiving a valid signal from the first camera.
